(19) United States
(12) Patent Application Publication
(10) Pub. No.: US 2006/0254532 A1
(43) Pub. Date: Nov. 16, 2006

(54) Automatic animal chute system

(76) Inventors: Delvin Boriack, Giddings, TX (US); Cale Boriack, Giddings, TX (US); Ordway Boriack, Giddings, TX (US)

Correspondence Address: Derek R. Van Gilder, 916 Main St., Bastrop, TX, 78602, US

(21) Appl. No.: 11/126,630

(22) Filed: May 11, 2005

(51) Int. Cl. A01K 1/06

(52) U.S. Cl. 119/730

(57) ABSTRACT

An automatic animal-chute system has at least one animal-chute control panel (1) on which chute-component controls (2) are positioned in control communication with component actuators (3) of operational components (4) of an animal chute (5) that is structurally formed for receiving an animal, retaining the animal for administering desired animal-care treatment to it and then releasing the animal. The component actuators can include pneumatic component actuators (19, 21, 22, 26, 27, 31, 57, 58, 59, 60), hydraulic component actuators (35, 36, 37, 38, 40, 41), electric component actuators (20, 25, 30, 34) and servomechanism actuators (48, 49, 50, 51, 52, 53, 54, 55, 56). The operational components can include a back gate (13) to the animal chute, a head gate (14) of the animal chute and animal-side squeezers (15). The animal chute can be structurally formed for receiving and retaining a select range of sizes of animals. Control communication with the component actuators can include pneumatic, hydraulic and electrical conveyances selectively. The control panel can be a fixed control panel (6) or a portable control panel (7), either of which can be operated manually or with levels of automation that allow one-person operation.

### BACKGROUND OF THE INVENTION

1. Field of the Invention

This invention relates to animal-handling chutes that are automated for remote control selectively.

2. Relation to Prior Art

There are animal-handling chutes which have controls for facilitating operation of separate chute components. Operating chute head gates, back gates, side squeezers, animal driving and treatment of animals in the chutes previously has been done by separate individuals. There have been no known automatic animal chute systems which provide control of system components automatically by a single individual with a single control unit that can be selectively remote in a manner taught by this invention.

Previous animal-handling chutes which do not have automated chute systems are described in the following patent documents.

| Patent Number | Inventor | Date |
|---|---|---|
| U.S. Pat. No. 4312299 | Leiker | 01-26-1982 |
| U.S. Pat. No. 4309963 | Forrest | 01-12-1982 |
| U.S. Pat. No. 4201157 | Lambert | 05-06-1980 |
| U.S. Pat. No. 3960113 | Kratky | 06-01-1976 |

### SUMMARY OF THE INVENTION

Objects of patentable novelty and utility taught by this invention are to provide an automatic animal-chute system which:

allows one individual to remote-control a plurality of chute-system components; and

decreases plurality of workers and time required for chute treatment of animals.

This invention accomplishes these and other objectives with an automatic animal-chute system having at least one animal-chute control panel on which chute-component controls are positioned in control communication with component actuators of operational components of an animal chute that is structurally formed for receiving an animal, retaining the animal for administering desired animal-care treatment to it and then releasing the animal. The component actuators can include pneumatic component actuators, hydraulic component actuators, electric component actuators or combination component actuators. The operational components can include a back gate to an animal chute, a head gate of the animal chute, animal-side squeezers, a left side gate, a right side gate, a head-gate adjuster, and an animal passageway to the back gate. The animal chute can be structurally formed for receiving and retaining a select range of sizes of animals. Control communication with the component actuators can include pneumatic, hydraulic and electrical conveyances selectively.

### BRIEF DESCRIPTION OF DRAWINGS

This invention is described by appended claims in relation to description of a preferred embodiment with reference to the following drawings which are explained briefly as follows:

FIG. 1 is a diagram of an automatic animal chute system with a fixed control panel, and with portable control panels with radio-wave and wire control of component actuators of operational components of an animal chute;

FIG. 2 is a top view of a portable control panel on an arm band;

FIG. 3 is a front view of a portable control panel on a neck band;

FIG. 4 is the FIG. 1 illustration with addition of selectively battery and public power sources for powering electrical motors of component actuators of the operational components of the animal chute through the animal-chute control panel;

FIG. 5 is the FIG. 1 illustration with central pneumatic operation of component actuators of the operational components of the animal chute through the animal-chute control panel;

FIG. 6 is a schematic representation of separate actuator pneumatic pumps with electrical current from a supply source and control from the fixed control panel for controlling a back gate that is attached openably and closably to an aft portion of the animal chute, for controlling a head gate that is attached openably and closably to a front portion of the animal chute and for controlling a squeezer that is attached openably and closably to side portions of the animal chute;

FIG. 7 is the FIG. 6 illustration with separate actuator hydraulic pumps instead of pneumatic pumps;

FIG. 8 is the FIG. 6 illustration with separate actuator servomechanisms;

FIG. 9 is a schematic representation of a central actuator pneumatic pump with control from the fixed control panel for controlling separate pneumatic cylinders that are linked to the back gate, to the head gate and to the squeezer which are attached openably and closably to respective portions of the animal chute.

FIG. 10 is a schematic representation of separate actuator pneumatic pumps with electrical current from a supply source and control from optionally the portable panel with radio wave or wire communication to the fixed control panel for controlling the back gate that is attached openably and closably to the aft portion of the animal chute, for controlling the head gate that is attached openably and closably to the front portion of the animal chute and for controlling the squeezer that is attached openably and closably to the side portions of the animal chute;

FIG. 11 is the FIG. 10 illustration with separate actuator hydraulic pumps instead of pneumatic pumps;

FIG. 12 is the FIG. 10 illustration with separate actuator servomechanisms; and

FIG. 13 is a schematic representation of a central actuator pneumatic pump with control from optionally the portable panel with radio wave or wire communication to the fixed control panel for controlling separate pneumatic cylinders that are linked to the back gate, to the head gate and to the squeezer which are attached openably and closably to respective portions of the animal chute.

### DESCRIPTION OF PREFERRED EMBODIMENT

A description of the preferred embodiment of this invention follows a list of numbered terms which designate its features with the same numbers on the drawings and in parentheses throughout the description and throughout the patent claims.

```
  1. Animal-chute control panel
  2. Chute-component controls
  3. Component actuators
  4. Operational components
  5. Animal chute
  6. Fixed control panel
  7. Portable control panel
  8. Portable-panel controls
  9. Arm band
10. Neck band
11. Radio waves
12. Electrical wires
13. Back gate
14. Head gate
15. Squeezer
16. Aft portion
17. Front portion
18. Side portions
19. Rear pneumatic pump
20. Rear electrical motor
21. Rear pneumatic cylinder
22. Rear pneumatic piston
23. Rear actuation member
24. Front pneumatic pump
25. Front electrical motor
26. Front pneumatic cylinder
27. Front pneumatic piston
28. Front actuation member
29. Squeezer pneumatic pump
30. Squeezer electrical motor
31. Squeezer pneumatic cylinder
32. Squeezer pneumatic piston
33. Rear hydraulic closed-loop pump
34. Rear electrical hydraulic motor
35. Rear hydraulic cylinder
36. Rear hydraulic piston
37. Rear hydraulic-piston shaft
38. Front hydraulic closed-loop pump
39. Front electrical hydraulic motor
40. Front hydraulic cylinder
41. Front hydraulic piston
42. Front hydraulic-piston shaft
43. Squeezer hydraulic closed-loop pump
44. Squeezer electrical hydraulic motor
45. Squeezer hydraulic cylinder
46. Squeezer hydraulic piston
47. Squeezer hydraulic-piston shaft
48. Rear servomechanism
49. Rear servomechanism motor
50. Rear servomechanism member
51. Front servomechanism
52. Front servomechanism motor
53. Front servomechanism member
54. Squeezer servomechanism
55. Squeezer servomechanism motor
56. Squeezer servomechanism member
57. Back pneumatic cylinder
58. Back pneumatic piston
59. Central pneumatic pump
60. Back pneumatic conveyance
61. Head pneumatic cylinder
62. Head pneumatic piston
63. Head pneumatic conveyance
64. Squeezer pneumatic cylinder
65. Squeezer pneumatic cylinder
66. Squeezer pneumatic conveyance
67. Battery power
68. Public power
69. Electrical motor
70. Pneumatic cylinders
71. Electrical power source
72. Squeezer-actuation member
73. Head switch
74. Proximity-sensor switch
75. Head release
76. Full-automation switch
77. Automation release
78. Squeezer-automation switch
79. Back-automation switch
```

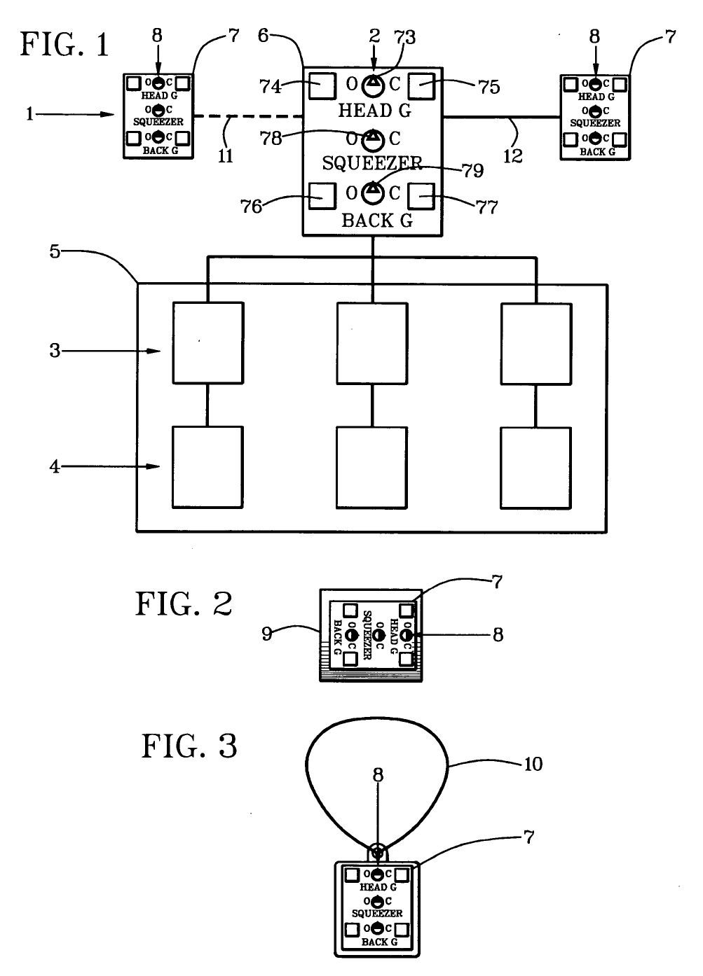

Referring to FIGS. 1-5, an automatic animal-chute system has at least one animal-chute control panel (1) with chute-component controls (2) positioned on the animal-chute control panel (1) for controlling component actuators (3) of a plurality of operational components (4) of a predetermined animal chute (5) that is structurally formed for receiving an animal, retaining the animal for animal-care treatment and then releasing the animal by operation of the operational components (4). The chute-component controls (2) are structurally formed for control of the component actuators (3).

The animal-chute control panel (1) can include a fixed control panel (6) that is structurally formed and positioned proximate the animal chute (5) predeterminedly for being accessed by an operator of the animal chute (5).

The animal-chute control panel (1) can include a portable control panel (7) that is portable by the operator of the animal chute (5). The portable control panel (7) has portable-panel controls (8) in control communication with the chute-component controls (2) for controlling operation of the operational components (4) with a latest control command from the chute-component controls (2) or the portable-panel controls (8) selectively.

The plurality of operational components (4) of the animal chute (5) can include a back gate (13), a head gate (14) and a squeezer (15).

The chute-component controls (2) can include a head switch (73) structurally formed for opening the head gate (14) by manually moving an indicator on the head switch (73) in a direction of an “O” on the animal-chute control panel (1) and for closing the head gate (14) by manually moving the indicator on the head switch (73) in a direction of a “C” on the animal-chute control panel (1).

The chute-component controls (2) can include a proximity-sensor switch (74) structurally formed for detecting presence of an animal head predeterminedly in the head gate (14) and for closing the head gate (14) predeterminedly onto a selected head-restraint portion of the animal. The proximity-sensor switch (74) can be optional to the head switch (73) for automated restraint of the animal.

The chute-component controls (2) can include a head release (75) structurally formed for releasing the head gate (14) touch-conveniently. The head release (75) can be optional to the head switch (73) for touch-convenient release of the animal.

The chute-component controls (2) can include a full-automation switch (76) structurally formed for actuating the proximity-sensor switch (74), for actuating a squeezer-automation switch (78) and for actuating a back-automation switch (79).

The squeezer-automation switch (78) can be structurally formed for applying side pressure of the squeezer (15) on opposite sides of the animal predeterminedly.

The back-automation switch (79) can be structurally formed for preventing rearward movement of the animal and for preventing entry of other animals into the animal chute (5) predeterminedly.

The chute-component controls (2) can include an automation release (77) structurally formed for releasing the head gate (14), the squeezer (15) and the back gate (13) predeterminedly with touch-convenience for allowing one-person operation of the animal chute system with the same one person treating animals lined up in a passageway to the back gate (13) and released into a predetermined area from the head gate (14).

The portable control panel (7) can be structurally formed for being fastened to a predetermined article on a body of the operator. The article on the body of the operator can include an arm band (9) or a neck band (10).

The control communication of the portable-panel controls (8) with the chute-component controls (2) can include wireless communication with radio waves (11) or electrical communication with electrical wires (12).

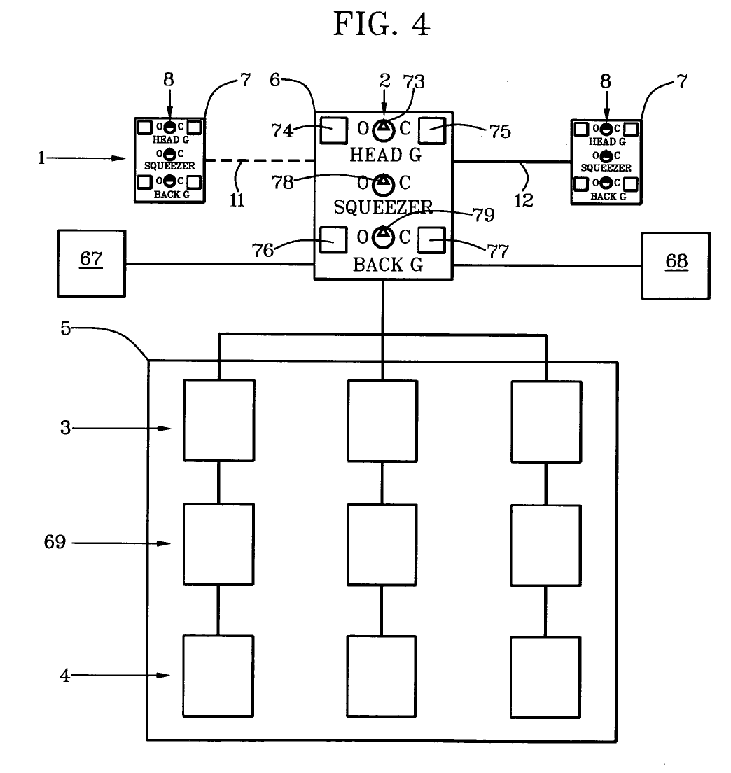

Battery power (67) and optionally public power (68) can be provided for electrical motors (69) to actuate the operational components (4) as shown in FIG. 4.

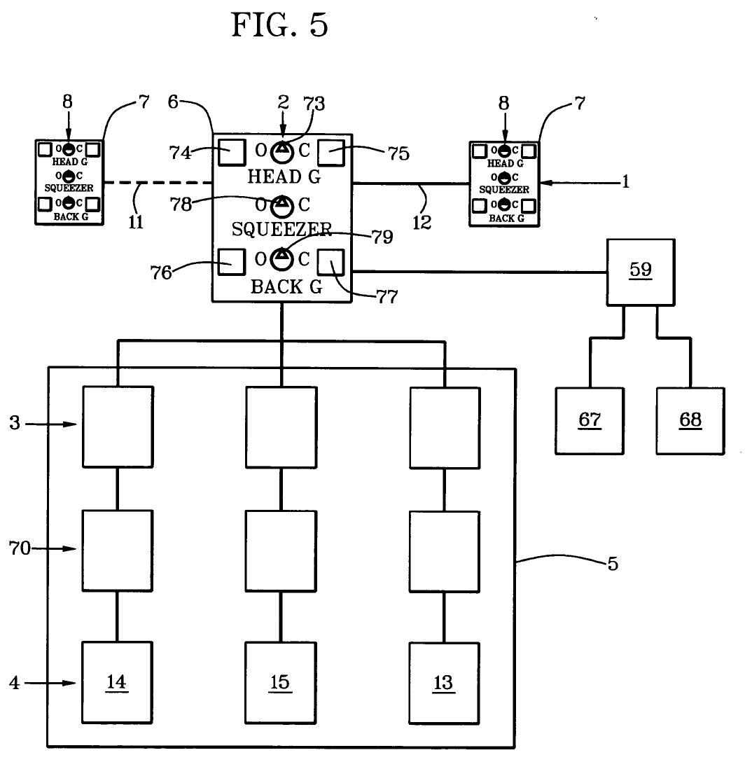

The operational components (4) can be actuated by pneumatic cylinders (70) with air pressure from a central pneumatic pump (59) that can be powered by the battery power (67) and optionally public power (68) as shown in FIG. 5.

Referring to FIGS. 4-8, the animal chute (5) can include a chute frame having an aft portion (16) to which the back gate (13) is attached openably and closably, a front portion (17) to which the head gate (14) is attached openably and closably and side portions (18) to which the squeezer (15) is attached openably and closably.

In the Livestock Industry, back gates (13) are usually hinged to a single side of an entry to an animal chute (5), but can be double-side hinged or slidable from either or both sides. The head gate (14) is often split and hinged on each side to allow two bay halves of a head aperture between the two sides, but also can be slidable from either or both sides. Squeezers (15) are often hinged to bottom sides of the animal chutes (5). This invention is intended for attachment of the component actuators (3) to the operational components (4) with whatever operational linkage is known and foreseeable within the art for closing and opening the operational components (4).

A schematic representation of the animal chute (5), its operational components (4) and component actuators (3) is employed for brevity to include operational linkages which are known and foreseeable within the art.

An electrical power source (71) can be provided for electrical motors (69) to actuate the operational components (4).

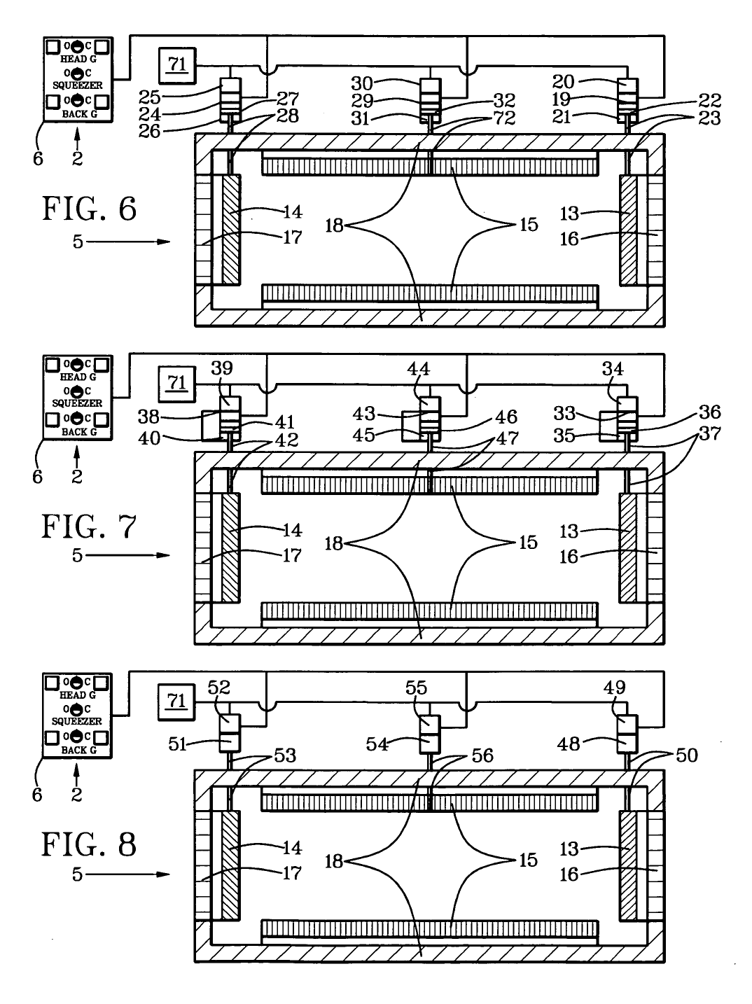

As shown in FIG. 6, the component actuators (3) can include a rear pneumatic pump (19) that is actuated by a rear electrical motor (20) that is structurally formed for pressurizing a rear pneumatic cylinder (21) in which a rear pneumatic piston (22) having a rear actuation member (23) linked predeterminedly to the back gate (13) is structurally formed to be forced in a gate-opening direction for opening the back gate (13) and in a gate-closing direction for closing the back gate (13) selectively by air pressure from the rear pneumatic pump (19).

The component actuators (3) can include a front pneumatic pump (24) that is actuated by a front electrical motor (25) that is structurally formed for pressurizing a front pneumatic cylinder (26) in which a front pneumatic piston (27) having a front actuation member (28) linked predeterminedly to the head gate (14) is structurally formed to be forced in a gate-opening direction for opening the head gate (14) and in a gate-closing direction for closing the head gate (14) selectively by air pressure from the front pneumatic pump (24).

The component actuators (3) can include a squeezer pneumatic pump (29) that is actuated by a squeezer electrical motor (30) that is structurally formed for pressurizing a squeezer pneumatic cylinder (31) in which a squeezer pneumatic piston (32) having a squeezer-actuation member (72) linked predeterminedly to the squeezer (15) is structurally formed to be forced in a squeezer-opening direction for opening the squeezer (15) and in a squeezer-closing direction for closing the squeezer (15) selectively by air pressure from the squeezer pneumatic pump (29).

As shown in FIG. 7, the component actuators (3) can include a rear hydraulic closed-loop pump (33) that is actuated by a rear electrical hydraulic motor (34) that is structurally formed for pressurizing a rear hydraulic cylinder (35) in which a rear hydraulic piston (36) having a rear hydraulic-piston shaft (37) linked predeterminedly to the back gate (13) is structurally formed to be forced in a gate-opening direction for opening the back gate (13) and in a gate-closing direction for closing the back gate (13) selectively by fluid pressure in closed-loop communication with the rear hydraulic closed-loop pump (33).

The component actuators (3) can include a front hydraulic closed-loop pump (38) that is actuated by a front electrical hydraulic motor (39) that is structurally formed for pressurizing a front hydraulic cylinder (40) in which a front hydraulic piston (41) having a front hydraulic-piston shaft (42) linked predeterminedly to the head gate (14) is structurally formed to be forced in a gate-opening direction for opening the head gate (14) and in a gate-closing direction for closing the head gate (14) selectively by fluid pressure in closed-loop communication with the front hydraulic closed-loop pump (38).

The component actuators (3) can include a squeezer hydraulic closed-loop pump (43) that is actuated by a squeezer electrical hydraulic motor (44) that is structurally formed for pressurizing a squeezer hydraulic cylinder (45) in which a squeezer hydraulic piston (46) having a squeezer hydraulic-piston shaft (47) linked predeterminedly to the squeezer (15) is structurally formed to be forced in a squeezer-opening direction for opening the squeezer (15) and in a squeezer-closing direction for closing the squeezer (15) selectively by fluid pressure in closed-loop communication with the squeezer hydraulic closed-loop pump (43).

As shown in FIG. 8, the component actuators (3) can include a rear servomechanism (48) that is structurally formed to be actuated by a rear servomechanism motor (49) for opening and for closing the back gate (13) with a rear servomechanism member (50) that is linked predeterminedly to the back gate (13).

The component actuators (3) can include a front servomechanism (51) that is structurally formed to be actuated by a front servomechanism motor (52) for opening and for closing the head gate (14) with a front servomechanism member (53) that is linked predeterminedly to the head gate (14).

The component actuators (3) can include a squeezer servomechanism (54) that is structurally formed to be actuated by a squeezer servomechanism motor (55) for opening and for closing the squeezer (15) with a squeezer servomechanism member (56) that is linked predeterminedly to the squeezer (15).

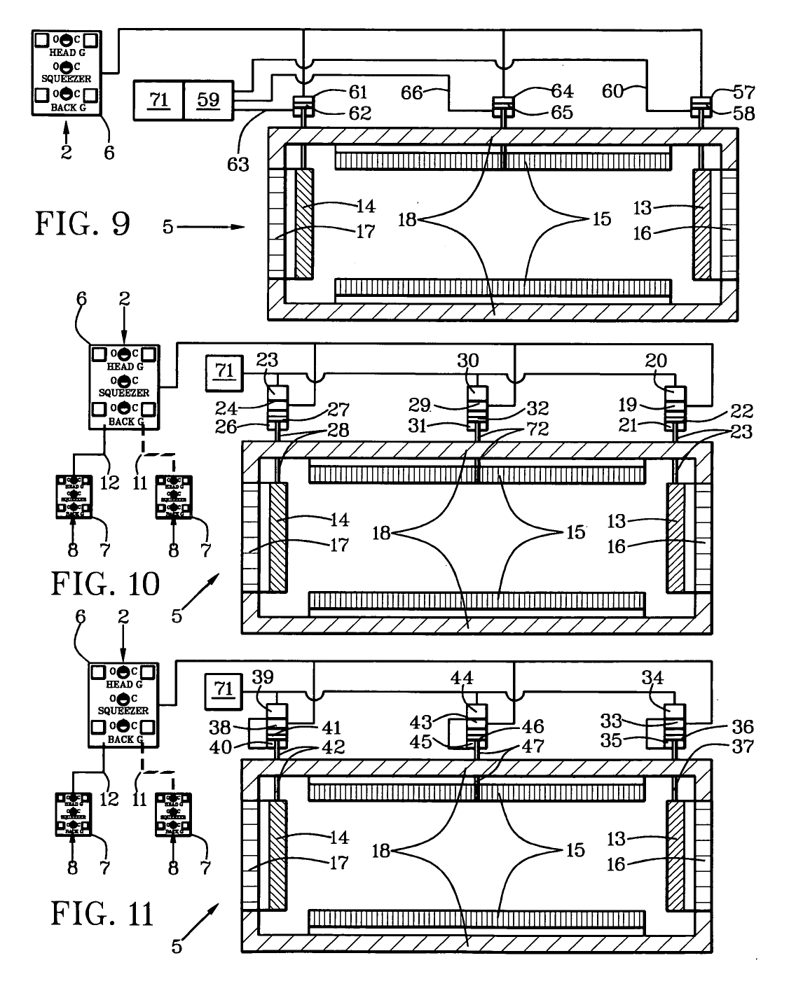

Referring to FIG. 9, the component actuators (3) can include a back pneumatic cylinder (57) having a back pneumatic piston (58) linked predeterminedly to the back gate (13) and being structurally formed for forcing the back gate (13) in a gate-opening direction for opening the back gate (13) and in a gate-closing direction for closing the back gate (13) selectively by air pressure in fluid communication from a central pneumatic pump (59) through back pneumatic conveyance (60). The component actuators (3) can include a head pneumatic cylinder (61) having a head pneumatic piston (62) linked predeterminedly to the head gate (14) and being structurally formed for forcing the head gate (14) in a gate-opening direction for opening the head gate (14) and in a gate-closing direction for closing the head gate (14) selectively by air pressure in fluid communication from the central pneumatic pump (59) through head pneumatic conveyance (63).

The component actuators (3) can include a squeezer pneumatic cylinder (64) having a squeezer pneumatic piston (65) linked predeterminedly to the squeezer (15) and being structurally formed for forcing the squeezer (15) in a squeezer-opening direction for opening the squeezer (15) and in a squeezer-closing direction for closing the squeezer (15) selectively by air pressure in fluid communication from the central pneumatic pump (59) through squeezer pneumatic conveyance (66).

Referring to FIGS. 10-12, the portable control panel (7) can have portable-panel controls (8) in control communication with the chute-component controls (2) of the fixed control panel (6) for controlling operation of the operational components (4) with a latest control command from the chute-component controls (2) and the portable-panel controls (8) selectively.

As shown in FIG. 10 with portable-panel control from the portable control panel (7) through optionally radio waves (11) or electrical wires (12), the component actuators (3) can include a rear pneumatic pump (19) that is actuated by a rear electrical motor (20) that is structurally formed for pressurizing a rear pneumatic cylinder (21) in which a rear pneumatic piston (22) having a rear actuation member (23) linked predeterminedly to the back gate (13) is structurally formed to be forced in a gate-opening direction for opening the back gate (13) and in a gate-closing direction for closing the back gate (13) selectively by air pressure from the rear pneumatic pump (19). The component actuators (3) can include a front pneumatic pump (24) that is actuated by a front electrical motor (25) that is structurally formed for pressurizing a front pneumatic cylinder (26) in which a front pneumatic piston (27) having a front actuation member (28) linked predeterminedly to the head gate (14) is structurally formed to be forced in a gate-opening direction for opening the head gate (14) and in a gate-closing direction for closing the head gate (14) selectively by air pressure from the front pneumatic pump (24).

The component actuators (3) can include a squeezer pneumatic pump (29) that is actuated by a squeezer electrical motor (30) that is structurally formed for pressurizing a squeezer pneumatic cylinder (31) in which a squeezer pneumatic piston (32) having a squeezer-actuation member (33) linked predeterminedly to the squeezer (15) is structurally formed to be forced in a squeezer-opening direction for opening the squeezer (15) and in a squeezer-closing direction for closing the squeezer (15) selectively by air pressure from the squeezer pneumatic pump (29).

As shown in FIG. 11 with portable-panel control from the portable control panel (7) through optionally radio waves (11) or electrical wires (12), the component actuators (3) can include a rear hydraulic closed-loop pump (33) that is actuated by a rear electrical hydraulic motor (34) that is structurally formed for pressurizing a rear hydraulic cylinder (35) in which a rear hydraulic piston (36) having a rear hydraulic-piston shaft (37) linked predeterminedly to the back gate (13) is structurally formed to be forced in a gate-opening direction for opening the back gate (13) and in a gate-closing direction for closing the back gate (13) selectively by fluid pressure in closed-loop communication with the rear hydraulic closed-loop pump (33). The component actuators (3) can include a front hydraulic closed-loop pump (38) that is actuated by a front electrical hydraulic motor (39) that is structurally formed for pressurizing a front hydraulic cylinder (40) in which a front hydraulic piston (41) having a front hydraulic-piston shaft (42) linked predeterminedly to the head gate (14) is structurally formed to be forced in a gate-opening direction for opening the head gate (14) and in a gate-closing direction for closing the head gate (14) selectively by fluid pressure in closed-loop communication with the front hydraulic closed-loop pump (38). The component actuators (3) can include a squeezer hydraulic closed-loop pump (43) that is actuated by a squeezer electrical hydraulic motor (44) that is structurally formed for pressurizing a squeezer hydraulic cylinder (45) in which a squeezer hydraulic piston (46) having a squeezer hydraulic-piston shaft (47) linked predeterminedly to the squeezer (15) is structurally formed to be forced in a squeezer-opening direction for opening the squeezer (15) and in a squeezer-closing direction for closing the squeezer (15) selectively by fluid pressure in closed-loop communication with the squeezer hydraulic closed-loop pump (43).

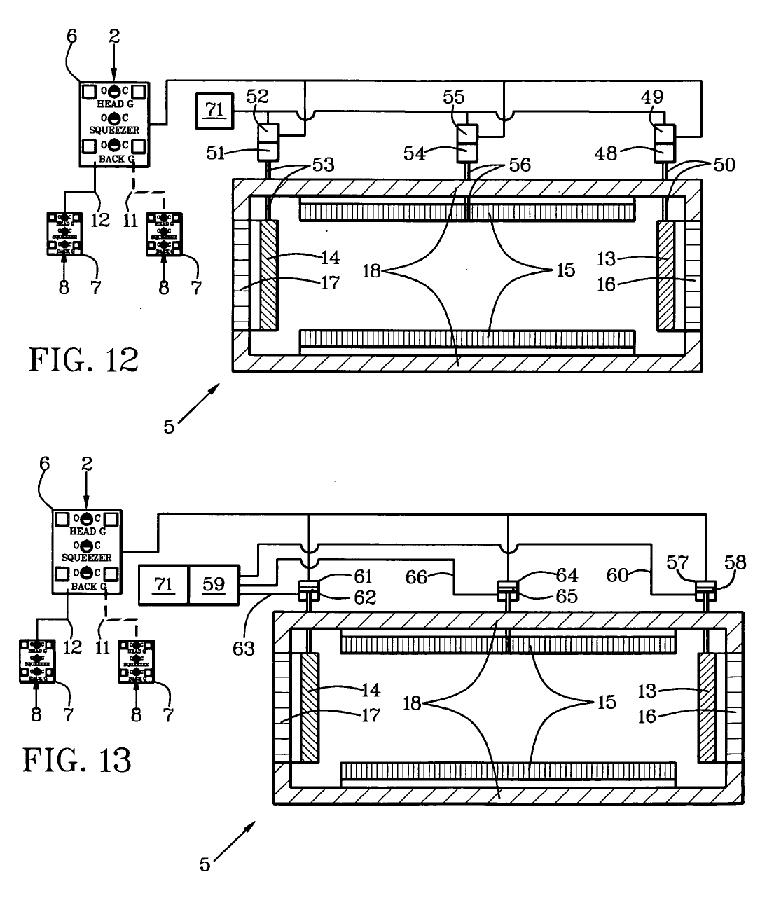

As shown in FIG. 12 with portable-panel control from the portable control panel (7) through optionally radio waves (11) or electrical wires (12), the component actuators (3) can include a rear servomechanism (48) that is structurally formed to be actuated by a rear servomechanism motor (49) for opening and for closing the back gate (13) with a rear servomechanism member (50) that is linked predeterminedly to the back gate (13). The component actuators (3) can include a front servomechanism (51) that is structurally formed to be actuated by a front servomechanism motor (52) for opening and for closing the head gate (14) with a front servomechanism member (53) that is linked predeterminedly to the head gate (14). The component actuators (3) can include a squeezer servomechanism (54) that is structurally formed to be actuated by a squeezer servomechanism motor (55) for opening and for closing the squeezer (15) with a squeezer servomechanism member (56) that is linked predeterminedly to the squeezer (15).

Referring to FIG. 13 with portable-panel control from the portable control panel (7) through optionally radio waves (11) or electrical wires (12), the component actuators (3) can include a back pneumatic cylinder (57) having a back pneumatic piston (58) linked predeterminedly to the back gate (13) and structurally formed for forcing the back gate (13) in a gate-opening direction for opening the back gate (13) and in a gate-closing direction for closing the back gate (13) selectively by air pressure in fluid communication from a central pneumatic pump (59) through back pneumatic conveyance (60). The component actuators (3) can include a head pneumatic cylinder (61) having a head pneumatic piston (62) linked predeterminedly to the head gate (14) and structurally formed for forcing the head gate (14) in a gate-opening direction for opening the head gate (14) and in a gate-closing direction for closing the head gate (14) selectively by air pressure in fluid communication from the central pneumatic pump (59) through head pneumatic conveyance (63). The component actuators (3) can include a squeezer pneumatic cylinder (64) having a squeezer pneumatic piston (65) linked predeterminedly to the squeezer (15) and structurally formed for forcing the squeezer (15) in a squeezer-opening direction for opening the squeezer (15) and in a squeezer-closing direction for closing the squeezer (15) selectively by air pressure in fluid communication from the central pneumatic pump (59) through squeezer pneumatic conveyance (66).

A new and useful automatic animal-chute system having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. An automatic animal-chute system comprising:
at least one animal-chute control panel (1);
chute-component controls (2) positioned on the animal-chute control panel (1);
component actuators (3) of a plurality of operational components (4) of a predetermined animal chute (5) that is structurally formed for receiving an animal, retaining the animal for animal-care treatment and then releasing the animal by operation of the operational components (4);
the chute-component controls (2) being structurally formed for control of the component actuators (3); and
the chute-component controls (2) being in control communication with the component actuators (3).

2. The automatic animal-chute system of claim 1 wherein:
the plurality of operational components (4) of the animal chute (5) include a back gate (13), a head gate (14) and a squeezer (15);
the animal chute (5) includes a chute frame having an aft portion (16) to which the back gate (13) is attached openably and closably, a front portion (17) to which the head gate (14) is attached openably and closably and side portions (18) to which the squeezer (15) is attached openably and closably; and
the chute-component controls (2) include a head switch (73) structurally formed for opening the head gate (14) by manually moving an indicator on the head switch (73) in a direction of an “O” on the animal-chute control panel (1) and for closing the head gate (14) by manually moving the indicator on the head switch (73) in a direction of a “C” on the animal-chute control panel (1).

3. An automatic animal-chute system comprising:
at least one animal-chute control panel (1);
chute-component controls (2) positioned on the animal-chute control panel (1);
component actuators (3) of a plurality of operational components (4) of a predetermined animal chute (5) that is structurally formed for receiving an animal, retaining the animal for animal-care treatment and then releasing the animal by operation of the operational components (4);
the chute-component controls (2) being structurally formed for control of the component actuators (3);
the chute-component controls (2) being in control communication with the component actuators (3);
the plurality of operational components (4) of the animal chute (5) include a back gate (13), a head gate (14) and a squeezer (15);
the animal chute (5) includes a chute frame having an aft portion (16) to which the back gate (13) is attached openably and closably, a front portion (17) to which the head gate (14) is attached openably and closably and side portions (18) to which the squeezer (15) is attached openably and closably;
the chute-component controls (2) include a proximity-sensor switch (74) structurally formed for detecting presence of an animal head predeterminedly in the head gate (14) and for closing the head gate (14) predeterminedly onto a selected head-restraint portion of the animal;
the proximity-sensor switch (74) being optional to the head switch (73) for automated restraint of the animal;
the chute-component controls (2) include a head release (75) structurally formed for releasing the head gate (14) touch-conveniently; and
the head release (75) being optional to the head switch (73) for touch-convenient release of the animal.

4. The automatic animal-chute system of claim 3 wherein:
the animal-chute control panel (1) includes a fixed control panel (6);
the fixed control panel (6) is structurally formed and positioned proximate the animal chute (5) predeterminedly for being accessed by an operator of the animal chute (5).

5. The automatic animal-chute system of claim 3 wherein:
the animal-chute control panel (1) includes a portable control panel (7) that is portable by the operator of the animal chute (5); and
the portable control panel (7) has portable-panel controls (8) in control communication with the chute-component controls (2) for controlling operation of the operational components (4) with a latest control command from the chute-component controls (2) and the portable-panel controls (8) selectively.

6. The automatic animal-chute system of claim 3 wherein:
the portable control panel (7) is structurally formed for being fastened to a predetermined article on a body of the operator.

7. The automatic animal-chute system of claim 6 wherein:
the article on the body of the operator includes an arm band (9).

8. The automatic animal-chute system of claim 6 wherein:
the article on the body of the operator includes a neck band (10).

9. The automatic animal-chute system of claim 3 wherein:
the control communication of the portable-panel controls (8) with the chute-component controls (2) includes wireless communication with radio waves (11).

10. The automatic animal-chute system of claim 3 wherein:
the control communication of the portable-panel controls (8) with the chute-component controls (2) includes electrical communication with electrical wires (12).

11. The automatic animal-chute system of claim 3 wherein:
the component actuators (3) include a rear pneumatic pump (19) that is actuated by a rear electrical motor (20) that is structurally formed for pressurizing a rear pneumatic cylinder (21) in which a rear pneumatic piston (22) having a rear actuation member (23) linked predeterminedly to the back gate (13) is structurally formed to be forced in a gate-opening direction for opening the back gate (13) and in a gate-closing direction for closing the back gate (13) selectively by air pressure from the rear pneumatic pump (19);
the component actuators (3) include a front pneumatic pump (24) that is actuated by a front electrical motor (25) that is structurally formed for pressurizing a front pneumatic cylinder (26) in which a front pneumatic piston (27) having a front actuation member (28) linked predeterminedly to the head gate (14) is structurally formed to be forced in a gate-opening direction for opening the head gate (14) and in a gate-closing direction for closing the head gate (14) selectively by air pressure from the front pneumatic pump (24); and
the component actuators (3) include a squeezer pneumatic pump (29) that is actuated by a squeezer electrical motor (30) that is structurally formed for pressurizing a squeezer pneumatic cylinder (31) in which a squeezer pneumatic piston (32) having a squeezer-actuation member (72) linked predeterminedly to the squeezer (15) is structurally formed to be forced in a squeezer-opening direction for opening the squeezer (15) and in a squeezer-closing direction for closing the squeezer (15) selectively by air pressure from the squeezer pneumatic pump (29).

12. The automatic animal-chute system of claim 3 wherein:
the component actuators (3) include a rear hydraulic closed-loop pump (33) that is actuated by a rear electrical hydraulic motor (34) that is structurally formed for pressurizing a rear hydraulic cylinder (35) in which a rear hydraulic piston (36) having a rear hydraulic-piston shaft (37) linked predeterminedly to the back gate (13) is structurally formed to be forced in a gate-opening direction for opening the back gate (13) and in a gate-closing direction for closing the back gate (13) selectively by fluid pressure in closed-loop communication with the rear hydraulic closed-loop pump (33);
the component actuators (3) include a front hydraulic closed-loop pump (38) that is actuated by a front electrical hydraulic motor (39) that is structurally formed for pressurizing a front hydraulic cylinder (40) in which a front hydraulic piston (41) having a front hydraulic-piston shaft (42) linked predeterminedly to the head gate (14) is structurally formed to be forced in a gate-opening direction for opening the head gate (14) and in a gate-closing direction for closing the head gate (14) selectively by fluid pressure in closed-loop communication with the front hydraulic closed-loop pump (38); and
the component actuators (3) include a squeezer hydraulic closed-loop pump (43) that is actuated by a squeezer electrical hydraulic motor (44) that is structurally formed for pressurizing a squeezer hydraulic cylinder (45) in which a squeezer hydraulic piston (46) having a squeezer hydraulic-piston shaft (47) linked predeterminedly to the squeezer (15) is structurally formed to be forced in a squeezer-opening direction for opening the squeezer (15) and in a squeezer-closing direction for closing the squeezer (15) selectively by fluid pressure in closed-loop communication with the squeezer hydraulic closed-loop pump (43).

13. The automatic animal-chute system of claim 3 wherein:
the component actuators (3) include a rear servomechanism (48) that is structurally formed to be actuated by a rear servomechanism motor (49) for opening and for closing the back gate (13) with a rear servomechanism member (50) that is linked predeterminedly to the back gate (13);
the component actuators (3) include a front servomechanism (51) that is structurally formed to be actuated by a front servomechanism motor (52) for opening and for closing the head gate (14) with a front servomechanism member (53) that is linked predeterminedly to the head gate (14); and
the component actuators (3) include a squeezer servomechanism (54) that is structurally formed to be actuated by a squeezer servomechanism motor (55) for opening and for closing the squeezer (15) with a squeezer servomechanism member (56) that is linked predeterminedly to the squeezer (15).

14. The automatic animal-chute system of claim 3 wherein:
the component actuators (3) include a back pneumatic cylinder (57) having a back pneumatic piston (58) linked predeterminedly to the back gate (13) is structurally formed for forcing the back gate (13) in a gate-opening direction for opening the back gate (13) and in a gate-closing direction for closing the back gate (13) selectively by air pressure in fluid communication from a central pneumatic pump (59) through back pneumatic conveyance (60);
the component actuators (3) include a head pneumatic cylinder (61) having a head pneumatic piston (62) linked predeterminedly to the head gate (14) is structurally formed for forcing the head gate (14) in a gate-opening direction for opening the head gate (14) and in a gate-closing direction for closing the head gate (14) selectively by air pressure in fluid communication from the central pneumatic pump (59) through head pneumatic conveyance (63); and
the component actuators (3) include a squeezer pneumatic cylinder (64) having a squeezer pneumatic piston (65) linked predeterminedly to the squeezer (15) is structurally formed for forcing the squeezer (15) in a squeezer-opening direction for opening the squeezer (15) and in a squeezer-closing direction for closing the squeezer (15) selectively by air pressure in fluid communication from the central pneumatic pump (59) through squeezer pneumatic conveyance (66).

15. The automatic animal-chute system of claim 14 and further comprising:
the portable control panel (7) having portable control panels (8) in control communication with the chute-component controls (2) for controlling operation of the operational components (4) with a latest control command from the component controls (2) or the portable-panel controls (8) selectively;
the component actuators (3) include a rear pneumatic pump (19) that is actuated by a rear electrical motor (20) that is structurally formed for pressurizing a rear pneumatic cylinder (21) in which a rear pneumatic piston (22) having a rear actuation member (23) linked predeterminedly to the back gate (13) is structurally formed to be forced in a gate-opening direction for opening the back gate (13) and in a gate-closing direction for closing the back gate (13) selectively by air pressure from the rear pneumatic pump (19);
the component actuators (3) include a front pneumatic pump (24) that is actuated by a front electrical motor (25) that is structurally formed for pressurizing a front pneumatic cylinder (26) in which a front pneumatic piston (27) having a front actuation member (28) linked predeterminedly to the head gate (14) is structurally formed to be forced in a gate-opening direction for opening the head gate (14) and in a gate-closing direction for closing the head gate (14) selectively by air pressure from the front pneumatic pump (24); and
the component actuators (3) include a squeezer pneumatic pump (29) that is actuated by a squeezer electrical motor (30) that is structurally formed for pressurizing a squeezer pneumatic cylinder (31) in which a squeezer pneumatic piston (32) having a squeezer-actuation member (72) linked predeterminedly to the squeezer (15) is structurally formed to be forced in a squeezer-opening direction for opening the squeezer (15) and in a squeezer-closing direction for closing the squeezer (15) selectively by air pressure from the squeezer pneumatic pump (29).

16. The automatic animal-chute system of claim 3 and further comprising:
the portable control panel (7) having portable control panels (8) in control communication with the chute-component controls (2) for controlling operation of the operational components (4) with a latest control command from the component controls (2) or the portable-panel controls (8) selectively;
the component actuators (3) include a rear hydraulic closed-loop pump (33) that is actuated by a rear electrical hydraulic motor (34) that is structurally formed for pressurizing a rear hydraulic cylinder (35) in which a rear hydraulic piston (36) having a rear hydraulic-piston shaft (37) linked predeterminedly to the back gate (13) is structurally formed to be forced in a gate-opening direction for opening the back gate (13) and in a gate-closing direction for closing the back gate (13) selectively by fluid pressure in closed-loop communication with the rear hydraulic closed-loop pump (33);
the component actuators (3) include a front hydraulic closed-loop pump (38) that is actuated by a front electrical hydraulic motor (39) that is structurally formed for pressurizing a front hydraulic cylinder (40) in which a front hydraulic piston (41) having a front hydraulic-piston shaft (42) linked predeterminedly to the head gate (14) is structurally formed to be forced in a gate-opening direction for opening the head gate (14) and in a gate-closing direction for closing the head gate (14) selectively by fluid pressure in closed-loop communication with the front hydraulic closed-loop pump (38); and
the component actuators (3) include a squeezer hydraulic closed-loop pump (43) that is actuated by a squeezer electrical hydraulic motor (44) that is structurally formed for pressurizing a squeezer hydraulic cylinder (45) in which a squeezer hydraulic piston (46) having a squeezer hydraulic-piston shaft (47) linked predeterminedly to the squeezer (15) is structurally formed to be forced in a squeezer-opening direction for opening the squeezer (15) and in a squeezer-closing direction for closing the squeezer (15) selectively by fluid pressure in closed-loop communication with the squeezer hydraulic closed-loop pump (43).

17. The automatic animal-chute system of claim 3 and further comprising:
the portable control panel (7) having portable control panels (8) in control communication with the chute-component controls (2) for controlling operation of the operational components (4) with a latest control command from the component controls (2) or the portable-panel controls (8) selectively;
the component actuators (3) include a rear servomechanism (48) that is structurally formed to be actuated by a rear servomechanism motor (49) for opening and for closing the back gate (13) with a rear servomechanism member (50) that is linked predeterminedly to the back gate (13);
the component actuators (3) include a front servomechanism (51) that is structurally formed to be actuated by a front servomechanism motor (52) for opening and for closing the head gate (14) with a front servomechanism member (53) that is linked predeterminedly to the head gate (14); and
the component actuators (3) include a squeezer servomechanism (54) that is structurally formed to be actuated by a squeezer servomechanism motor (55) for opening and for closing the squeezer (15) with a squeezer servomechanism member (56) that is linked predeterminedly to the squeezer (15).

18. The automatic animal-chute system of claim 3 and further comprising:
the portable control panel (7) having portable control panels (8) in control communication with the chute-component controls (2) for controlling operation of the operational components (4) with a latest control command from the component controls (2) or the portable-panel controls (8) selectively;
the component actuators (3) include a back pneumatic cylinder (57) having a back pneumatic piston (58) linked predeterminedly to the back gate (13) is structurally formed for forcing the back gate (13) in a gate-opening direction for opening the back gate (13) and in a gate-closing direction for closing the back gate (13) selectively by air pressure in fluid communication from a central pneumatic pump (59) through back pneumatic conveyance (60);
the component actuators (3) include a head pneumatic cylinder (61) having a head pneumatic piston (62) linked predeterminedly to the head gate (14) is structurally formed for forcing the head gate (14) in a gate-opening direction for opening the head gate (14) and in a gate-closing direction for closing the head gate (14) selectively by air pressure in fluid communication from the central pneumatic pump (59) through head pneumatic conveyance (63); and
the component actuators (3) include a squeezer pneumatic cylinder (64) having a squeezer pneumatic piston (65) linked predeterminedly to the squeezer (15) is structurally formed for forcing the squeezer (15) in a squeezer-opening direction for opening the squeezer (15) and in a squeezer-closing direction for closing the squeezer (15) selectively by air pressure in fluid communication from the central pneumatic pump (59) through squeezer pneumatic conveyance (66).

19. An automatic animal-chute system comprising:
at least one animal-chute control panel (1);
chute-component controls (2) positioned on the animal-chute control panel (1);
component actuators (3) of a plurality of operational components (4) of a predetermined animal chute (5) that is structurally formed for receiving an animal, retaining the animal for animal-care treatment and then releasing the animal by operation of the operational components (4);
the chute-component controls (2) being structurally formed for control of the component actuators (3);
the chute-component controls (2) being in control communication with the component actuators (3);
the plurality of operational components (4) of the animal chute (5) includes a back gate (13), a head gate (14) and a squeezer (15);
the animal chute (5) includes a chute frame having an aft portion (16) to which the back gate (13) is attached openably and closably, a front portion (17) to which the head gate (14) is attached openably and closably and side portions (18) to which the squeezer (15) is attached openably and closably;
the chute-component controls (2) include a proximity-sensor switch (74) structurally formed for detecting presence of an animal head predeterminedly in the head gate (14) and for closing the head gate (14) predeterminedly onto a selected head-restraint portion of the animal;
the chute-component controls (2) include a full-automation switch (76) structurally formed for actuating the proximity-sensor switch (74), for actuating a squeeze automation switch (78) and for actuating a back-automation switch (79);
the squeeze automation switch (78) being structurally formed for applying side pressure of the squeezer (15) on opposite sides of the animal predeterminedly;
the back-automation switch (79) being structurally formed for preventing rearward movement of the animal and for preventing entry of other animals into the animal chute (5) predeterminedly; and
the chute-component controls (2) include an automation release (77) structurally formed for releasing the head gate (14), the squeezer (15) and the back gate (13) predeterminedly with touch-convenience for allowing one-person operation of the animal chute system and treating of animals lined up in a passageway to the back gate (15) and released into a predetermined area from the head gate (14).

20. The water-hydrogen engine system of claim 19 and further comprising:
the portable control panel (7) having portable control panels (8) in control communication with the chute-component controls (2) for controlling operation of the operational components (4) with a latest control command from the component controls (2) or the portable-panel controls (8) selectively.
